(19) United States
(12) Patent Application Publication
(10) Pub. No.: US 2007/0194556 A1
(43) Pub. Date: Aug. 23, 2007

(54) Double Trailer Assembly

(76) Inventor: Hubert T. Kleysen, Winnipeg (CA)

Correspondence Address: ADE & COMPANY INC., 2157 Henderson Highway, WINNIPEG, MB, R2G1P9, US

(21) Appl. No.: 11/564,042

(22) Filed: Nov. 28, 2006

Related U.S. Application Data
(60) Provisional application No. 60/764,765, filed on Feb. 3, 2006.

(51) Int. Cl. B62D 53/08

(52) U.S. Cl. 280/476.1

(57) ABSTRACT

A double trailer assembly for supporting elongate loads includes a lead trailer frame connected to a highway truck tractor and a pup trailer frame connected to the lead trailer frame. A lead swivel bunk supports the front end of the load on the lead trailer frame on lead wheels and a pup swivel bunk supports the rear end of the load on the pup trailer frame on pup wheels. The lead swivel bunk is slidable together with the lead wheels relative to the lead frame while the pup swivel bunk is slidable together with the pup wheels relative to the pup frame for adjusting wheelbase of the lead trailer for optimising handling at highway speeds, traction, load distribution or tracking of the trailers during low speed cornering for example. Relative sliding between the lead swivel bunk, the lead wheels and the lead trailer frame can be selectively restricted at a selected relative positioning therebetween.

This application claims the benefit under 35 U.S.C. 119(e) of U.S. provisional application Ser. No. 60/764,765, filed Feb. 3, 2006.

### FIELD OF THE INVENTION

The present invention relates to a double trailer assembly for being towed by a highway truck tractor, and more particularly relates to a double trailer assembly including a lead trailer and a pup trailer, each with a swivel bunk thereon for supporting elongate loads spanning the swivel bunks of the trailers.

### BACKGROUND

For transporting elongate loads on highways, it is known to use a double trailer assembly generally comprising a lead trailer towing a pup trailer articulated therewith in which the lead and pup trailers support swivel bunks respectively thereon so that the load may span between the swivel bunks,

U.S. Pat. No. 5,393,084 to Kleysen discloses one such example of a swivel bunked double trailer assembly, which is hereby incorporated by reference. In the prior art example the swivel bunk supported on the lead trailer is fixed in longitudinal positioning while being pivotal about a vertical axis of the bunk The rear end of the load is supported on a rear swivel bunk on the pup trailer, which in addition to being supported for pivotal movement about a vertical axis, is also supported for longitudinal sliding movement along the frame of the pup trailer for accommodating the varying distance required between the bunks when the lead trailer and pup trailer are articulated relative to one another about a corner. This configuration is well suited for cargo such as a conventional length intermodal container and the like. For much longer loads however the prior art example occasionally has difficulty in cornering as the pup trailer does not track very well with the lead trailer and highway truck tractor due to a much longer wheelbase required for proper load distribution. The prior art examples of swivel bunked trailers are also limited in their ability to redistribute the load among the wheel groups of the trailer and tractor as may be desired for different driving conditions.

### SUMMARY OF THE INVENTION

According to one aspect of the invention there is provided a double trailer assembly for transporting an elongate load using a highway truck tractor, the assembly comprising:

a lead trailer comprising:

a lead trailer frame extending in a respective longitudinal direction from a front end, including a coupling for towing connection to the highway truck tractor, to a rear end;

lead wheels supporting the lead trailer frame thereon for rolling movement along the ground;

a lead swivel bunk for supporting a front end of the elongate load thereon, the lead swivel bunk being pivotally supported on the lead trailer frame for relative pivotal movement about a respective vertical pivot axis of the lead swivel bunk;

the lead wheels and the lead swivel bunk being slidable together relative to the lead trailer frame in the longitudinal direction of the lead trailer frame; and

a latching mechanism for selectively restricting sliding movement of the lead swivel bunk and lead wheels relative to the lead trailer frame; and

a pup trailer comprising,

a pup trailer frame extending in a respective longitudinal direction from a front end, including a coupling for towing connection to the rear end of the lead trailer frame, to a rear end;

rear wheels supporting the pup trailer frame thereon for rolling movement along the ground; and

a pup swivel bunk for supporting a rear end of the elongate load thereon; the pup swivel bunk being pivotally supported on the pup trailer frame for relative pivotal movement about a respective vertical pivot axis of the pup swivel bunk;

the pup swivel bunk being slidable relative to the pup trailer frame in the longitudinal direction of the pup trailer frame.

By supporting the lead swivel bunk and lead wheels together for longitudinal sliding movement along the lead trailer frame, the wheelbase of the lead trailer can be selectively shortened when desired. This shorter wheelbase causes the pup trailer to better track the tractor and the lead trailer when cornering. Furthermore when displacing the lead swivel bunks together with the lead wheels forwardly along the lead trailer frame, the load supported on the bunks can be redistributed forwardly to the tractor for improving traction on the wheels of the tractor as desired, for example for climbing hills. The latch mechanism readily permits the tractor to drive forwardly and rearwardly to displace the trailer frames relative to the wheels and swivel bunks coupled thereto for displacing the wheels and swivel bunks readily between foremost and rearmost positions. A sliding displacement in the longitudinal direction of approximately eight feet for example, is sufficient to considerably shift some of the load to the wheels of the tractor while having a significant effect on the wheelbase to improve the cornering ability. In the preferred embodiment the pup wheels are slidable along the length of the pup trailer frame along with the pup swivel bunk to minimize redistribution of the load at the rear end of the trailer while still serving to shorten the wheelbase of the overall tractor and trailer rig.

According to another aspect of the present invention there is provided a lead trailer for use with a pup trailer in a double trailer assembly for transporting an elongate load using a highway truck tractor, in which the pup trailer comprises: a pup trailer frame extending in a respective longitudinal direction from a front end, including a coupling for towing connection to the lead trailer, to a rear end; rear wheels supporting the pup trailer frame thereon for rolling movement along the ground; and a pup swivel bunk for supporting a rear end of the elongate load thereon; the pup swivel bunk being pivotally supported on the pup trailer frame for relative pivotal movement about a respective vertical pivot axis of the pup swivel bunk; the pup swivel bunk being slidable relative to the pup trailer frame in the longitudinal direction of the pup trailer frame, the lead trailer comprising:

a lead trailer frame extending in a respective longitudinal direction from a front end, including a coupling for towing connection to the highway truck tractor, to a rear end;

lead wheels supporting the lead trailer frame thereon for rolling movement along the ground;

a lead swivel bunk for supporting a front end of the elongate load thereon, the lead swivel bunk being pivotally supported on the lead trailer frame for relative pivotal movement about a respective vertical pivot axis of the lead swivel bunk;

the lead wheels and the lead swivel bunk being slidable together relative to the lead trailer frame in the longitudinal direction of the lead trailer frame; and

a latching mechanism for selectively restricting sliding movement of the lead swivel bunk and lead wheels relative to the lead trailer frame.

Preferably, the rear wheels are supported for sliding movement in the longitudinal direction relative to the pup trailer frame. The pup swivel bunk and the rear wheels may be coupled for sliding movement together relative to the pup trailer frame in the longitudinal direction of the pup trailer frame. Relative sliding movement between the pup swivel bunk and the pup trailer frame is preferably unrestricted.

The lead swivel bunk may be supported spaced ahead of the lead wheels at a fixed spacing while the lead swivel bunk and the lead wheels are slidably displaced in the longitudinal direction relative to the lead trailer frame.

There may be provided a lubricating layer engaging an upwardly facing surface of the lead trailer frame adjacent the lead swivel bunk and a further lubricating layer engaging a downwardly facing surface of the lead trailer frame adjacent the lead wheels.

The lead swivel bunk is preferably slidably displaced relative to the lead trailer frame between a rearmost position in which the lead swivel bunk is positioned approximately mid-length along the lead trailer frame and a foremost position in which the swivel bunk is nearer to a front end of the lead trailer frame in relation to the rearmost position. The lead swivel bunk preferably engages a rear stop on the lead trailer in the rearmost position and preferably engages a forward stop on the lead trailer frame in the foremost position.

The pup swivel bunk may be located directly above the rear wheels.

There may also be provided a lubricating layer engaging upwardly facing surfaces of the pup trailer frame adjacent the pup swivel bunk and the rear wheels.

The pup swivel bunk is preferably slidably displaced along the pup trailer frame from a rearmost position adjacent the rear end of the frame to a foremost position in which the pup swivel bunk is nearer to a longitudinal center of the frame in relation to the rearmost position.

Preferably, the swivel bunks are slidable together relative to the lead trailer frame and the pup trailer frame respectively from the rearmost position in which the lead swivel bunk is located approximately mid-length along the lead trailer frame and the pup swivel bunk is located adjacent the rear end of the pup trailer frame and a foremost position in which the lead swivel bunk is nearer to a front end of the lead trailer frame and the pup swivel bunk is nearer to a mid-length location along the pup trailer frame in relation to the rearmost position.

When provided in combination with an elongate load which is fixed in length, the load is preferably supported at a front end on the lead swivel bunk and at a rear end on the pup swivel bunk. When the load comprises elongate pipes, the swivel bunks preferably include brackets for supporting the pipes thereon.

One embodiment of the invention will now be described in conjunction with the accompanying drawings in which:

### BRIEF DESCRIPTION OF THE DRAWINGS

FIG. 1 is a side elevational view of the double trailer assembly with the swivel bunks shown in a rearmost position for normal use driving.

FIG. 2 is a side elevational view of the double trailer assembly with the swivel bunks in a foremost position for improved cornering and varied weight distribution relative to the rearmost position of FIG. 1.

FIG. 3 is a top plan view of the double trailer assembly in the rearmost position.

FIG. 4 is a top plan view of the double trailer assembly in the foremost position.

FIG. 5 is a sectional view along the line 5-5 of FIG. 1.

FIG. 6 and FIG. 7 are respective schematic top plan views of the double trailer assembly while cornering in a rearmost and foremost position respectively.

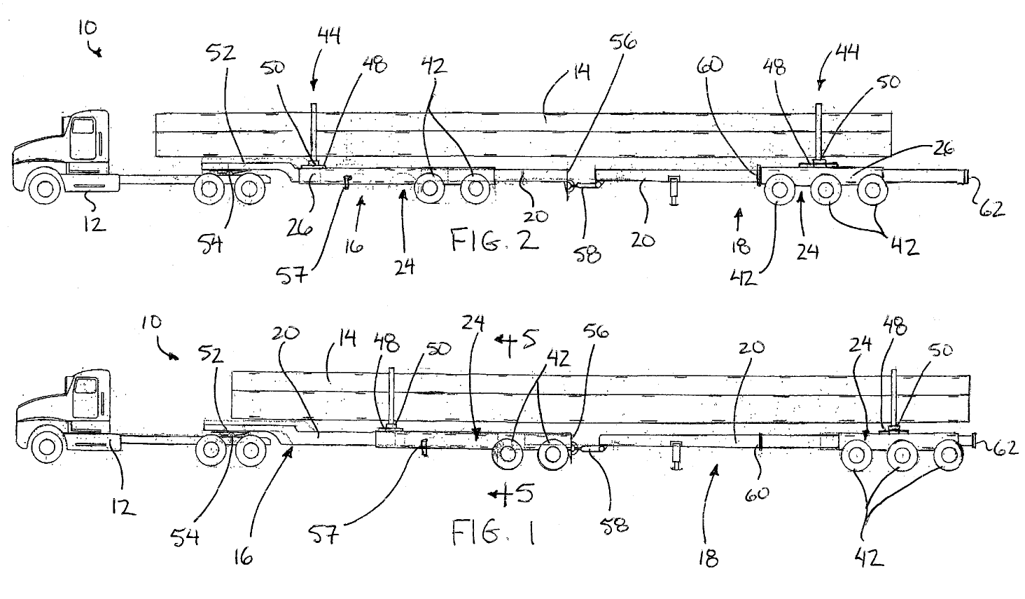

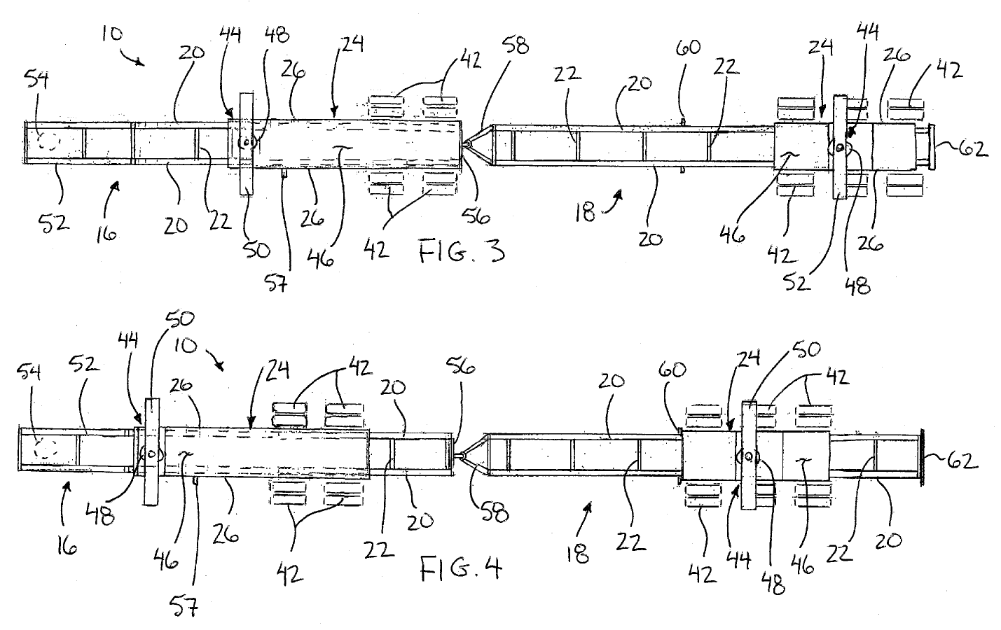

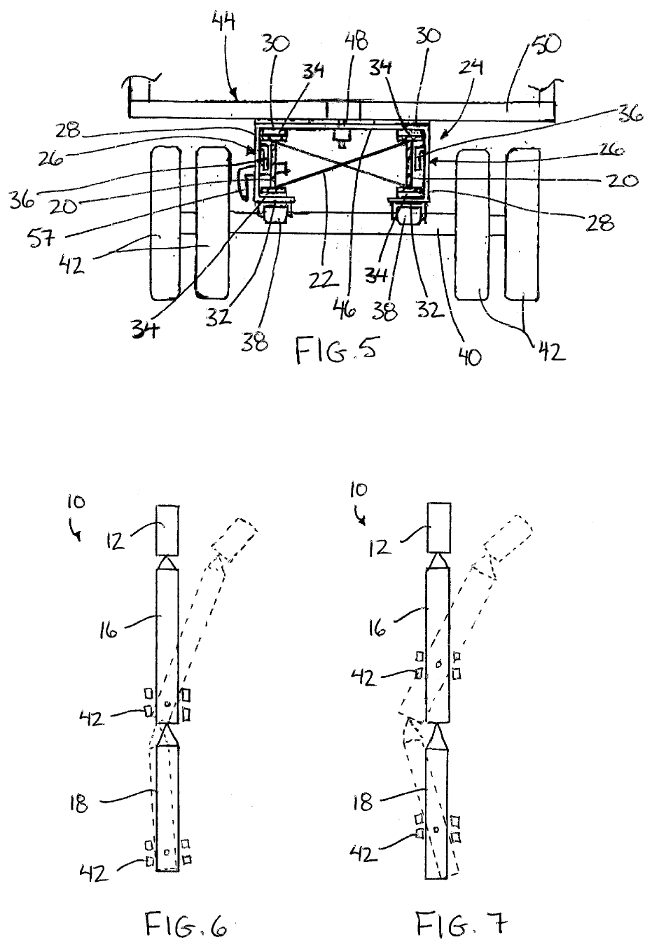

In the drawings like characters of reference indicate corresponding parts in the different figures.

### DETAILED DESCRIPTION

Referring the accompanying figures there is illustrated a double trailer assembly generally indicated by reference numeral 10. The assembly 10 is particularly suited for being towed by a highway tractor truck 12 to transport elongate loads 14, for example pipe for large diameter pipelines and the like.

The assembly 10 generally includes a lead trailer 16 extending in a respective longitudinal direction from a front end, coupled to the tractor 12, to a respective rear end. The assembly 10 further includes a pup trailer 18 which also extends in a respective longitudinal direction from a front end, coupled to the rear end of the lead trailer 16 for relative articulating movement about an upright axis, to a respective rear end.

Each of the lead trailer 16 and the pup trailer 18 comprises a frame including two parallel and spaced apart beams 20 which substantially extend a full length of the trailer frame in the longitudinal direction. Each of the beams comprises a steal I-beam in which the central web is vertically oriented between top and bottom flanges of the beam. The two parallel beams are supported in their spaced apart configuration by suitable cross bracing 22 spanning therebetween. Each of the frames of the trailers 16 and 18 includes a carriage 24 which is slidably supported along the beams thereof. Each carriage 24 comprises two opposed channels 26 supported on opposing longitudinally extending sides of the frame. The channels are generally C-shaped in cross-section, including a vertical side plate 28 which extends between a top flange 30 and a bottom flange 32. Each of the top and bottom flanges extends inwardly from a respective edge of the side plate. The top flange 30 of each channel rides along the top flange of the respective beam 20 of the frame while the bottom flange 32 overlaps the bottom flange of the respective beam 20.

A lubricating layer 34 of ultrahigh molecular weight plastic material, or some other durable material having a low coefficient of friction, is provided between the top and bottom surfaces of each beam 20 at locations where the top and bottom flanges 30 and 32 of the respective channels of the carriage ride along.

Auxiliary flanges 36 in the form L-shaped brackets project inwardly and downwardly from the opposing side plates 28 of the carriage for mating engagement just beneath the top flanges of the respective beams 20 of the trailer frame. An additional lubricating layer 34 of material having a low coefficient of friction is provided between mating surfaces of the auxiliary flanges 36 and the underside and exterior side of the top flanges of the beam 20.

The carriage 24 is supported on suspension components 38 for carrying the carriage 24 on the wheel axles 40 of respective wheels 42 of the trailers. The wheels 42 serve to support the respective trailers for rolling movement along the ground. The carriage 24 is coupled to the wheels 42 in such a manner so that the wheels are slidably displaced in the longitudinal direction of the trailer relative to the trailer frame together with the carriage 24.

A swivel bunk 44 is supported on the top side of each carriage 24 at a fixed longitudinal positioning relative to the carriage so that the swivel bunk 44 is slidable together with the carriage 24 and wheels 24 upon which it is supported. Each carriage includes a top plate 46 which spans between the top flanges 30 of the opposed channels of the carriage at the location of the swivel bunk 44 for supporting the swivel bunk 44 thereon.

Each swivel bunk 44 comprises a suitable bushing support 48 mounted in the top plate 46 so as to mount a load support member 50 thereon for rotation about a vertical axis of the swivel bunk. The load support member 50 generally comprises an elongate rigid member which is typically oriented transversely to the longitudinal direction of the trailer to extend substantially the full width of the trailer or more. In the illustrated embodiment, the load support member 50 is suitably configured for transporting elongate pipe material thereon.

Turning now more particularly to only the lead trailer 16, the front end of the frame is provided with a gooseneck 52 incorporating a fifth wheel coupling 54 for connection to the towing tractor in a conventional manner for relative articulating movement about an upright axis. The carriage 24 of the lead trailer extends approximately twenty feet in length in the illustrated embodiment and is carried on two axles spaced apart from one another in the longitudinal direction adjacent the rear end of the carriage. The swivel bunk 44 supported on the carriage 24 on the lead trailer 16 is spaced forwardly ahead of a foremost one of the axles by approximately ten feet in the illustrated embodiment so that the swivel bunk 44 is cantilevered spaced ahead of the wheels adjacent the front end of the carriage on the lead trailer.

In this instance the lubricating layer 34 is primarily required on the top side of the beams adjacent the front end of the carriage and on the bottom sides of the beams 20 adjacent the rear end of the carriage by the wheel axles. The carriage is longitudinally slidable along the lead trailer frame between the rearmost position, in which a rear end of the carriage is abutted against an end plate 56 at a rear end of the trailer frame to function as a stop, and the foremost position, in which the front end of the carriage engages the gooseneck to similarly act as a stop which restricts further sliding movement.

A latching mechanism 57 is provided on the carriage 24 of the lead trailer 16 for being selectively engaged between the carriage and the frame to restrict relative sliding movement therebetween in the longitudinal direction when engaged. The latching mechanism 57 comprises a locking pin which is slidable into and out of engagement with co-operating apertures in the carriage 24 and the frame of the lead trailer 16. The latching mechanism can be manually released and re-engaged as desired by the operator and serves to latch longitudinal positioning of the carriage along with the wheels upon which it is supported relative to the frame in either one of a foremost or rearmost position of the swivel bunks.

In the rearmost position, the wheels of the carriage are supported at the rear end of the carriage and at the rear end of the trailer frame with the bunk being spaced forwardly in relation thereto so as to be near the middle of the trailer frame in the longitudinal direction. When advanced by approximately eight feet as shown in the illustrated embodiment from the rearmost position to the foremost position, the wheels are positioned closer to the middle of the trailer while the swivel bunk is ahead of the midpoint of the trailer at the front end of the frame adjacent the gooseneck. Position of the swivel bunk on the lead trailer is fixed in relation to the respective carriage 24 upon which it is supported so that the swivel bunk and wheels of the lead trailer are always movable together in the longitudinal direction relative to the trailer frame upon which they are supported.

Turning now only to the pup trailer 18, the frame in this instance includes a suitable coupling 58 at the front end thereof which couples the front end of the pup trailer to the rear end of the lead trailer for relative articulating movement about an upright axis by one of various conventional means.

The carriage 24 of the pup trailer 18 extends longitudinally approximately twelve feet in the illustrated embodiment and is supported on a set of three wheels axles which are equally spaced apart in the longitudinal direction. The swivel bunk 44 in this instance is supported on the carriage 24 above the central one of the axles within the bushing support 48 at a fixed longitudinal position relative to the carriage 24 and wheels 42 upon which the frame is supported.

The swivel bunk of the pup trailer 18 thus remains pivotal within the respective bushing support 48 while also being slidable in the longitudinal direction with the carriage and wheels of the pup trailer between the foremost and rearmost positions thereof along the frame of the pup trailer.

The swivel bunk 44 and wheels 42 of the pup trailer are coupled together for unrestricted sliding movement along the frame of the pup trailer. The unrestricted sliding movement of the swivel bunk 44 relative to the frame of the pup trailer is required for accommodating changing length of the frames of the trailers between the swivel bunks 44 while maintaining the swivel bunks at a fixed spacing when cornering.

Stops 60 are provided centrally along the frame of the pup trailer for abutting the front end of the carriage in the foremost position of the carriage and wheels of the pup trailer relative to the trailer frame of the pup trailer. An end plate 62 is also provided at the rear end of the frame of the pup trailer 18 to prevent sliding movement of the carriage beyond the rear end of the frame. In the rearmost position, the carriage 24 on the pup trailer remains spaced forwardly in relation to the end plate 62 when driving straight ahead so that when cornering, the carriage 24 is permitted to be temporarily displaced rearward towards the end plate 62 to maintain a fixed spacing between the swivel bunks 44 as the lead trailer and pup trailer are articulated relative to one another.

The lubricating layer 34 in the pup trailer is primarily required between the top side of the beams 20 and the inside surface of the top flanges of the channels forming the carriage slidable thereon.

In the rearmost position of the wheels 42 and swivel bunk 44 of the pup trailer 18, the wheels are positioned adjacent the rear end of the trailer frame with the swivel bunk of the pup trailer being supported directly thereabove adjacent the rear end of the frame as well. When displaced forwardly by approximately eight feet in the illustrated example, to the foremost position, the wheels of the pup trailer are spaced forwardly from the rear end thereof towards the center of the frame. The swivel bunk 44 of the pup trailer remains supported above the rear wheels 42 of the pup trailer so as to be supported closer towards the longitudinal center of the trailer.

Under normal use, for example when driving along the highway, it is desirable to maintain a longer wheelbase for improved stability at highway speeds. The elongate load 14 is supported at its front end on the swivel bunk 44 on the lead trailer 16 while the rear end of the elongate load is supported on the swivel bunk 44 of the pup trailer 18 so that with the load spanning the double trailer assembly, the length between the swivel bunk 44 on the lead trailer and the swivel bunk 44 on the pup trailer remains fixed between the vertical pivot axes thereof.

The resulting longer wheelbase however causes difficulty when cornering at intersections with restricted space. To improve tracking of the pup trailer behind the lead trailer and the tractor, the operator first stops the double trailer assembly at the side of the road and unpins the carriage 24 from the frame of the lead trailer 16. The swivel bunks 44 which are joined by the load 14, cause the carriages 24 of the lead and pup trailers to be slidable together relative to the respective frames of the trailers. From the rearmost position of the carriages, the driver displaces the tractor rearwardly along with the trailer frames coupled thereto while the wheels supported on the carriages along with the bunks supported thereon remain fixed relative to the ground until they are slidably displaced relative to the trailer frames sufficiently that the carriages reach the foremost position. At this point the carriage 24 of the lead trailer is again pinned relative to the frame of the lead trailer using the latching mechanism 57 to restrict any further relative sliding movement therebetween.

Forward displacement of the bunks serves to transfer weight of the load 14 to the wheels of the tractor 12 for increased traction as desired. In addition, once in the foremost position, the wheels of the lead trailer are positioned forwardly of the rear end of the lead trailer and its articulated coupling to the pup trailer. FIG. 7 illustrates an example of a rig which is cornering when the wheels are advanced into the foremost position. The pup trailer 18 in this instance tracks the lead trailer and tractor much better than in the rearmost position shown in FIG. 6. When making a right turn as shown in FIG. 7 as an example, the lead trailer effectively pivots about a generally upright axis near the wheels of the lead trailer so that when in the foremost position, the coupling between the lead trailer and the pup trailer is resultingly displaced much farther to the left. The pup trailer 18 thus begins to follow a path which tracks the lead trailer and the tractor much more closely to better form the turn rather than causing the pup trailer to out across the corner as is typical with a longer wheelbase.

To return to a longer wheelbase for again driving on the highway with better stabilization, the latching mechanism 57 of the carriage 24 of the lead trailer is again released When subsequently driving forwardly, the tractor pulls the pup trailer frame and the lead trailer frame relative to the respective carriages so that the carriages are effectively slidably displaced rearwardly relative to the frames into the rearmost position. The wheels and the respective bunks of each trailer are slidable together into the rearmost position through connection to the load 14 of fixed length between the bunks. The carriage 24 of the lead trailer is subsequently pinned in place with the latching mechanism 57 to restrict any further relative sliding when resuming driving in the rearmost position.

Since various modifications can be made in my invention as herein above described, and many apparently widely different embodiments of same made within the spirit and scope of the claims without department from such spirit and scope it is intended that all matter contained in the accompanying specification shall be interpreted as illustrative only and not in a limiting sense.

1. A double trailer assembly for transporting an elongate load using a highway truck tractor, the assembly comprising:
a lead trailer comprising:
a lead trailer frame extending in a respective longitudinal direction from a front end, including a coupling for towing connection to the highway truck tractor to a rear end;
lead wheels supporting the lead trailer frame thereon for rolling movement along the ground;
a lead swivel bunk for supporting a front end of the elongate load thereon, the lead swivel bunk being pivotally supported on the lead trailer frame for relative pivotal movement about a respective vertical pivot axis of the lead swivel bunk;
the lead wheels and the lead swivel bunk being slidable together relative to the lead trailer frame in the longitudinal direction of the lead trailer frame; and
a latching mechanism for selectively restricting sliding movement of the lead swivel bunk and lead wheels relative to the lead trailer frame; and
a pup trailer comprising:
a pup trailer frame extending in a respective longitudinal direction from a front end, including a coupling for towing connection to the rear end of the lead trailer frame, to a rear end;
rear wheels supporting the pup trailer frame thereon for rolling movement along the ground; and
a pup swivel bunk for supporting a rear end of the elongate load thereon; the pup swivel bunk being pivotally supported on the pup trailer frame for relative pivotal movement about a respective vertical pivot axis of the pup swivel bunk;
the pup swivel bunk being slidable relative to the pup trailer frame 5 in the longitudinal direction of the pup trailer frame.

2. The assembly according to claim 1 wherein the rear wheels are supported for sliding movement in the longitudinal direction relative to the pup trailer frame.

3. The assembly according to claim 2 wherein the pup swivel bunk and the rear wheels are coupled for sliding movement together relative to the pup trailer frame in the longitudinal direction of the pup trailer frame.

4. The assembly according to claim 1 wherein relative sliding movement between the pup swivel bunk and the pup trailer frame is unrestricted.

5. The assembly according to claim 1 wherein the lead swivel bunk is supported spaced ahead of the lead wheels at a fixed spacing while the lead swivel bunk and the lead wheels are slidably displaced in the longitudinal direction relative to the lead trailer frame.

6. The assembly according to claim 1 wherein there is provided a lubricating layer engaging an upwardly facing surface of the lead trailer frame adjacent the lead swivel bunk and wherein there is provided a lubricating layer engaging a downwardly facing surface of the lead trailer frame adjacent the lead wheels.

7. The assembly according to claim 1 wherein the lead swivel bunk is slidably displaced relative to the lead trailer frame between a rearmost position in which the lead swivel bunk is positioned approximately mid-length along the lead trailer frame and a foremost position in which the swivel bunk is nearer to a front end of the lead trailer frame in relation to the rearmost position.

8. The assembly according to claim 1 wherein the pup swivel bunk is located directly above the rear wheels.

9. The assembly according to claim 8 wherein there is provided a lubricating layer engaging upwardly facing surfaces of the pup trailer frame adjacent the pup swivel bunk and the rear wheels.

10. The assembly according to claim 1 wherein the pup swivel bunk is slidably displaced along the pup trailer frame from a rearmost position adjacent the rear end of the frame to a foremost position in which the pup swivel bunk is nearer to a longitudinal center of the frame in relation to the rearmost position.

11. The assembly according to claim 1 wherein the swivel bunks are slidable together relative to the lead trailer frame and the pup trailer frame respectively from the rearmost position in which the lead swivel bunk is located approximately mid-length along the lead trailer frame and the pup swivel bunk is located adjacent the rear end of the pup trailer frame and a foremost position in which the lead swivel bunk is nearer to a front end of the lead trailer frame and the pup swivel bunk is nearer to a mid-length location along the pup trailer frame in relation to the rearmost position.

12. The assembly according to claim 1 in combination with an elongate load which Is fixed in length between a front end supported on the lead swivel bunk and a rear end supported on the pup swivel bunk.

13. The assembly according to claim 12 wherein the elongate load comprises elongate pipes and wherein the swivel bunks include brackets for supporting the pipes thereon.

14. The assembly according to claim 1 wherein the lead swivel bunk is slidable between a rearmost position engaging a rear stop on the lead trailer frame and a foremost position engaging a forward stop on the lead trailer frame.

15. A lead trailer for use with a pup trailer in a double trailer assembly for transporting an elongate load using a highway truck tractor, in which the pup trailer comprises: a pup trailer frame extending in a respective longitudinal direction from a front end, including a coupling for towing connection to the lead trailer, to a rear end; rear wheels supporting the pup trailer frame thereon for rolling movement along the ground; and a pup swivel bunk for supporting a rear end of the elongate load thereon; the pup swivel bunk being pivotally supported on the pup trailer frame for relative pivotal movement about a respective vertical pivot axis of the pup swivel bunk; the pup swivel bunk being slidable relative to the pup trailer frame in the longitudinal direction of the pup trailer frame, the lead trailer comprising:
a lead trailer frame extending in a respective longitudinal direction from a front end, including a coupling for towing connection to the highway truck tractor, to a rear end;
lead wheels supporting the lead trailer frame thereon for rolling movement along the ground;
a lead swivel bunk for supporting a front end of the elongate load thereon, the lead swivel bunk being pivotally supported on the lead trailer frame for relative pivotal movement about a respective vertical pivot axis of the lead swivel bunk;
the lead wheels and the lead swivel bunk being slidable together relative to the lead trailer frame in the longitudinal direction of the lead trailer frame; and
a latching mechanism for selectively restricting sliding movement of the lead swivel bunk and lead wheels relative to the lead trailer frame.

16. The trailer according to claim 15 wherein the lead swivel bunk is supported spaced ahead of the lead wheels at a fixed spacing while the lead swivel bunk and the lead wheels are slidably displaced in the longitudinal direction relative to the lead trailer frame.

17. The trailer according to claim 15 wherein there is provided a lubricating layer engaging an upwardly facing surface of the lead trailer frame adjacent the lead swivel bunk and wherein there is provided a lubricating layer engaging a downwardly facing surface of the lead trailer frame adjacent the lead wheels.

18. The trailer according to claim 15 wherein the lead swivel bunk is slidably displaced relative to the lead trailer frame between a rearmost position in which the lead swivel bunk is positioned approximately mid-length along the lead trailer frame and a foremost position in which the swivel bunk is nearer to a front end of the lead trailer frame in relation to the rearmost position.

19. The trailer according to claim 15 wherein the lead swivel bunk is slidable between a rearmost position engaging a rear stop on the lead trailer frame and a foremost position engaging a forward stop on the lead trailer frame.
